(19) United States
(12) Patent Application Publication
(10) Pub. No.: US 2021/0346938 A1
(43) Pub. Date: Nov. 11, 2021

(54) METHOD AND DEVICE FOR PRODUCING A HELICAL METAL BODY

(71) Applicant: Fraunhofer-Gesellschaft zur Förderung der angewandten Forschung e.V., Muenchen (DE)

(72) Inventors: Franz-Josef Wöstmann, Bremen (DE); Michael Heuser, Bremen (DE); Matthias Busse, Bremen (DE)

(21) Appl. No.: 17/277,711

(22) PCT Filed: Sep. 19, 2019
(86) PCT No.: PCT/EP2019/075197

§ 371 Date: Mar. 18, 2021

(30) Foreign Application Priority Data
Sep. 19, 2018 (DE) 10 2018 215 977.7

(51) Int. Cl. B21J 5/00; B22D 25/02; B22C 7/02; H02K 15/04

(52) U.S. Cl. CPC B21J 5/002; B22D 25/02; H02K 15/045; H02K 15/0407; B22C 7/023

(57) ABSTRACT

The invention relates to a method for producing a helical metal body (Γ), in which initially a preformed, helical metal body is produced in a mould by a casting method and is subsequently compressed along its longitudinal axis by deformation.

The invention lies in the field of mechanical engineering and production technology, in particular metal casting. It can be used particularly advantageously in the production of coils, spirals or springs.

Wound coils are used in electrical machines. The coils thus produced only fill part of the available installation space. There results therefrom a lower power- or torque density of the electrical machines, relative to the weight or the constructional space. Cast Al- and Cu coils can compensate for this disadvantage, however to date no methods suitable for series production are known for the production of cast Al- and Cu coils or cast coils made of Al- and Cu alloys in permanent moulds with sufficient lifespans.

In order to increase the power density or the torque density of electrical machines, to date complex, often manually produced coils have been wound in order to improve the degree of filling slightly relative to series methods. Over the height of the windings, wire with the same cross-section is thereby used. Furthermore, in the case of conventional electrical machines, the windings of the coil which are situated one upon the other from the inside to the outside impair the heat discharge and lead to higher heating of the coils and hence to a necessary limitation of the maximum current density relative to the cross-section of the winding.

Cast Al- and Cu coils or cast coils made of Al- and Cu alloys are already known, however have not been produced to date in permanent moulds, but rather in lost form, such as e.g. in precision casting or in the lost foam method or by the use of salt cores which prescribe the contour and prevent direct contact of the melt with the mould.

For the production of the most varied of geometries, a contour-providing mould is used according to the state of the art. In the case of complex geometries, in addition to the mould which has one or more divisions for simple cast part removal, cores are inserted or slides are used.

In the production of copper components, as a result of the high casting temperature, above 1,100° C., there are increased requirements on the mould and core. The thermal stress and in particular the temperature shock during filling of the mould lead to a low mould lifespan and to a limit in the component quality or to the requirement for complex subsequent machining.

Previous mould concepts always led to geometrically complex permanent moulds or to the additional use of movable slides or cores (permanent or non-permanent). Such moulds could only be used in laboratory operation because great expenditure was required for maintaining the moulds and in addition high reject rates were present.

A geometrically modified model geometry which enables a simply formed two-part permanent mould for the casting process is known from patent application EP 2 819 276 A2. This is achieved by the windings being rotated respectively by 180° and hence the geometric complexity of the coil being significantly reduced. However according to the technical casting production there, an ultracomplex reforming process is required in order to arrive at the coil geometry in the insertion state.

The object underlying the present invention is to achieve a simple production method for coiled metal bodies, which method allows an economic use of casting moulds and thereby enables a high degree of filling of the spiral.

The object is achieved, according to the invention, by a method having the features of patent claim 1, patents claims 2 to 7 present embodiments of the method. Patent claims 8 to 10 relate to a device for the production of coiled metal bodies.

Therefore, the invention relates to a method for the production of a helical metal body in which firstly a preformed, helical metal body is produced in a mould by a casting method and thereupon is compressed by deformation along its longitudinal axis.

The invention allows the production of a helical body by casting, the mould being able to have a relatively thick-walled configuration as a result of a sufficiently large spacing between individual spiral threads. Deformation of the metal body after the casting process leaves clearances in the design of the shape which is produced by casting. After the casting, the target shape of the metal body can then be achieved by deformation, substantially smaller intermediate spaces being able to be achieved in the target shape between the individual threads of the spirals, which intermediate spaces, in casting technology, are scarcely achievable or only with great difficulty as a result of the limits which are set by the mould.

The method can be designed such that the metal body is compressed along its longitudinal axis at least partially by plastic deformation after the casting.

Plastic deformation of the metal body ensures that its target shape is stable and is maintained without fixing means.

The method can be configured, furthermore, such that the metal body is machined after the casting and before the compression, in particular by grinding and/or polishing and/or coating.

As a result of the fact that for example the intermediate spaces between the spiral threads and also other parts of the metal body in the preformed state are more easily accessible after casting than after achieving the target shape, the mentioned machining steps can be implemented more conveniently before deformation/compression of the metal body into the target shape.

The method can be configured, furthermore, such that, for compression of the helical metal body, the latter is pushed onto a mandrel with a free end and a first stop shoulder and that the free end of the mandrel is inserted into a receiving means with a second stop shoulder until the metal body is compressed between the stop shoulders.

Since the metal body also already has a helical configuration in the mould which it adopts with the casting process, it can be easily pushed on to a mandrel and compressed there in the direction of the longitudinal axis of the spiral. A first stop shoulder on the side of the mandrel serves for this purpose. The receiving means has for example an opening into which the mandrel, but not the metal body, can be inserted.

On the opening, the second stop shoulder can then be provided. When inserting the mandrel into the opening of the receiving means, the helical metal body is then compressed, between the first and the second metal shoulder, in the longitudinal direction up to the target shape or even beyond.

The method can be configured, furthermore, such that, during production of the preformed metal body in each winding of the spiral, at least one, in particular at least two deformation regions are provided or produced in particular by a material cross-sectional tapering and are deformed at first plastically during compression of the body.

In the case of a coil-shaped spiral, which is rectangular in cross-section, the deformation regions can be provided respectively on the shorter or even on the longer sides of the individual threads/windings of the spiral or on the corners of the individual windings of the spiral. The cross-sectional taperings can be provided in fact in the mould of the metal body.

The method can be configured, furthermore, such that the metal body is fixed by fixing means with respect to its length after the compression.

The fixing can be effected for example by immersion in a coating material or encapsulation or by applying an external mechanical cramp/clamp which holds together the windings of the spiral axially. The cramp/clamp must then consist either of a nonconductive material or be electrically insulated from the metal body.

The method can be configured, furthermore, such that firstly a lost model body, in particular made of a non-metallic material, is produced in the desired target shape of the compressed coiled metal body such that the model body is expanded by predeformation along the longitudinal axis and such that the expanded model body is used as positive mould for the casting of the predeformed metal body, in particular by producing a mould for the casting method with the help of the model body or by use in a melting method.

The model body is hence predeformed after production thereof by the spirals being expanded in the axial direction. Also, the model body may already be provided with cross-sectional taperings in order to provide weakened deformation regions on the subsequently cast metal body. From this predeformed model body, the metal body is then reshaped and possibly machined. Thereafter, the metal body is brought into its target shape by compression.

In addition, the invention relates to a device for the production of a coiled metal body of the above-described type, having a mandrel which has a free end and, at a spacing from the free end, a first stop shoulder which is dimensioned such that it forms a limit stop for a coiled metal body pushed onto the mandrel and having a receiving means which has an opening for inserting the free end of the mandrel and also a second stop shoulder for the metal body, surrounding the opening.

The device can be designed such that the mandrel has outer dimensions, in the region of the first stop shoulder, which enable a form-fit receiving of the preformed metal body and such that the mandrel tapers to its free end in at least a first extension direction of its cross-section. The mandrel can advantageously have the shape and size of the central continuous axial opening in the target shape of the metal body. For better threading into the metal body before its final deformation, the mandrel has a tapering/narrowing at its free end. The first stop shoulder can be configured as a flange on the mandrel.

The device can be configured, furthermore, such that, as a result of the shaping of the mandrel and of the receiving means, a longitudinal stop for insertion of the mandrel into the receiving means is formed, which fixes the length of the compressed helical metal body.

In the following, the invention is shown and subsequently explained on the basis of embodiments in Figures of a drawing. There are thereby shown

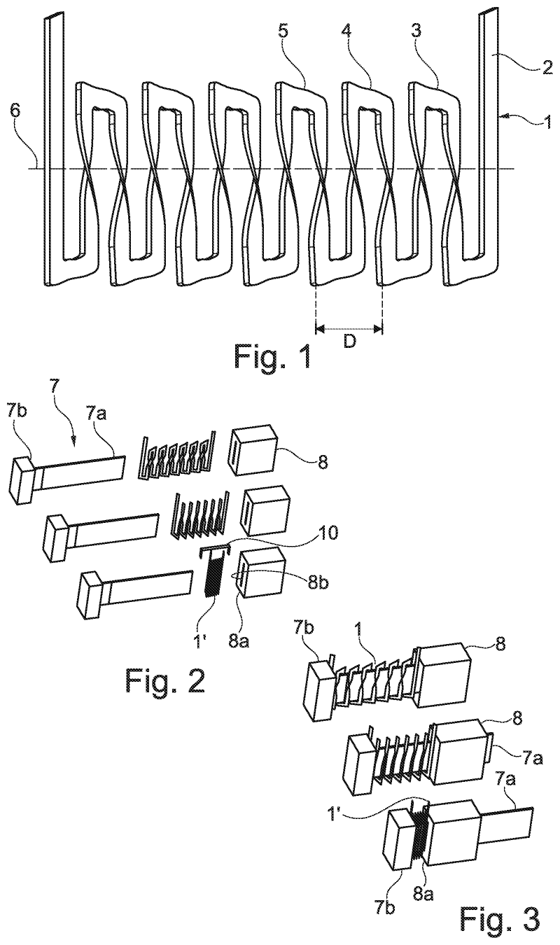

FIG. 1 a perspective illustration of a helical body,

FIG. 2 in three successive stages, a helical body which is compressed along the longitudinal axis of the spiral,

FIG. 3 in three successive stages, a helical body which is compressed along the longitudinal axis of the spiral onto a mandrel of a machining device between two stop shoulders,

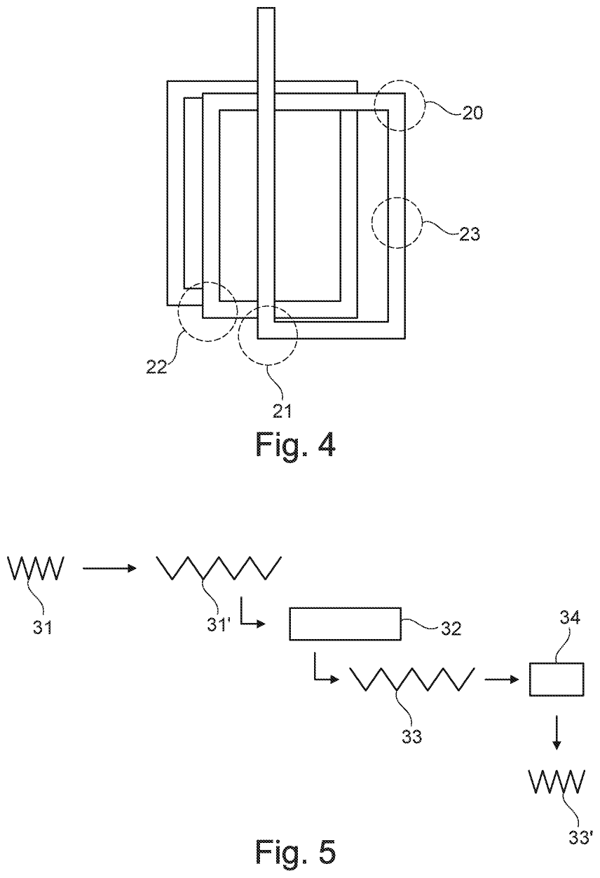

FIG. 4 a helical body with illustrated deformation regions, and also

FIG. 5 schematically, the production process when using a model body.

In the following, the production of lost models for use in precision casting by means of a simple mould concept is described. The complexity of the coil geometry for the lost model is reduced specifically by plastic reshaping of the winding head in combination with a rotation of the long winding side by <=90° in order to enable the use of a simple two-part mould concept for the production of cast parts (inter alia metal pressure casting, low-pressure casting, chill casting, metal-powder injection moulding) or model plates or lost models (inter alia in wax injection moulding, in sand casting, sand casting with Disamatic, EPS models for lost foam). For this purpose, the winding head and the winding (long lamellae) are reshaped in the case of a model body, on the one hand, such that they adopt the shape illustrated in FIG. 1. FIG. 1 represents the shape of a model body which can have firstly the target shape of the helical metal body and thereafter is predeformed in order to shape the mould for the metal body by expansion along the longitudinal axis 6. However, this shape also corresponds to that of a helical metal body after casting and before compression in the longitudinal direction 6. The terminals on the winding head 2 and also the individual windings 3, 4, 5 of the spiral are illustrated. For the casting process of the metal body to be produced, the individual windings of the spiral have the enlarged spacing D. As a result, filigree and complex regions are avoided in the mould design.

Hence a robust, maintenance-friendly concept for any type of plug-in coils is produced.

As a result of the predeformation on the winding head and rotation in the winding on the model, the manufacture, suitable for large series production, of cast coils in the permanent mould method and lost models and also lost moulds is made possible. After the casting process, the casting system can be retained in order to supply the melt for the following process step as handling aid for the cast part. This has the advantage in particular that the actual cast article, which often consists of pure aluminium (R99.7 or similar) or E-copper and has a very low strength and also high ductility, is protected from additional plastic deformation. The cast coil is fixed in the predeformed position which is very advantageous for the following subsequent process steps and enables automated processes. In particular process steps such as deburring, polishing, cleaning, grinding and coating methods are simplified significantly by the improved accessibility on the basis of the predeformed coil with increased winding spacing. The subsequent processes can be effected before or after removal of the casting system or only after further subsequent process steps (grinding, polishing and coating for electrical insulation). An additional advantage of this geometry variant is the simple reshaping process after the casting by inserting a guide rod into the core of the winding/spiral and direct reshaping of the windings in succession.

This is achieved by the threading-in of a mandrel with a stop shoulder, as illustrated in FIG. 2. FIG. 2 shows in three successive stages, from top to bottom, three different compression steps of the helical metal body, there being illustrated at the top an uncompressed shape, in the centre a partially compressed shape and at the bottom a completely compressed shape, along the longitudinal axis, of the helical metal body 1′. On the left-hand side of the metal body, respectively a mandrel 7 with a free end 7a and a first stop shoulder 7b is illustrated, whilst, on the right-hand side, respectively a receiving means 8 with a second stop shoulder 8a and an opening 8b for receiving the free end 7a of the mandrel 7 is shown.

The metal body (1′) can remain, either by plastic deformation after the compression in the target shape shortened at the bottom in FIG. 2, or it can be retained compressed by fixing means 10. Such fixing means can consist for example of a mechanical cramp/clamp 10. However, the metal body can also be fixed for example by gluing with an insulating material which, at the same time, insulates the windings of the spiral from each other.

FIG. 3 shows, one below the other, in three different stages, the insertion of a mandrel 7 into a helical metal body 1 and thereby the progressive compression of the helical metal body in the direction of its longitudinal axis 6 which extends parallel to the longitudinal axis of the mandrel 7. With the help of the mandrel 7 and the receiving means 8, the coil is deformed in the target state/insertion state. Reshaping process and calibration can hereby be combined. The compression can be continued until, after a relaxation of elastic deformation components by the remaining plastic deformation, the target shape is achieved. At its free end 7a, the mandrel is thin in order to simplify the threading-in and becomes thicker towards the first stop shoulder 7b and corresponds there by its cross-section to the end contour of the interior of the spiral. Ideally, the end contour of the interior of the spiral has at least the same height as the coil/helical metal body in its target shape.

In FIG. 4, it is shown that, at specific points of the helical metal body, deformation regions 10, 11, 12, 13 can be provided, which can be reduced for example in the material cross-section in order to leave the elastic deformation region at these points precisely in the case of low deformation and for transition to a plastic deformation. Hence the proportion of elastic deformation during compression of the metal body is reduced and the target shape can be better estimated in advance and achieved. The deformation regions can be provided for example at the corners of the windings or also on the straight portions of the windings.

In FIG. 5, firstly a model body 11 manufactured in the target shape is illustrated schematically. The latter is changed into a predeformed model body 11′ expanded in the longitudinal direction and then converted, by means of a reshaping process, into a metal body 13 in a likewise expanded shape. This can then be machined in potential working steps 14, for example by deburring and/or coating and is thereupon compressed to form the metal body 13′.

By combination of the winding head, predeformed relative to the target shape, and rotating of the winding in the predeformed state by less than 90 degrees relative to the target shape, the following advantages are achieved: by the combined and variable adaptation of the modification of the winding head and simultaneous rotating of the coil by an angle which is less than 90°, the mould concept can be used for any type and size of plug-in coils. No draughts are required at relevant points on the windings (parallel-edge and non-parallel-edge windings achievable), as a result a manufacture-caused reduction in the groove filling factor is avoided. The predeformed coil can be reshaped by simple pushing together, with the help of a mandrel, into the insertion state. The mandrel geometry can thereby be designed such that a calibration into the end geometry is implemented directly with the reshaping. A small projection area of the tool enables the use of smaller injection machines, smaller moulds or multiple cavities.

The invention can be used in the production of cast coils in the most varied of sizes (e.g. small geometries, in with steering motors, required for permanent moulds in Al pressure moulding or MIM for Cu coils; large coils can be produced in the lost foam or sand casting).

A further advantage of the invention is optionally the possibility of using shell precision casting instead of using block mould methods. This is made possible by the predeformation.

Between the individual windings, sufficient space is produced in the case of the casting mould in order to enable the shell construction in precision casting. The problem of the shells growing one on the other in the mould of thin-wall moulds/in the case of too small a spacing of the individual spiral threads is avoided.

Burrs produced on the coiled metal body during the casting are readily accessible before the final deformation and can be removed automatically also for example.

A closed shell/ceramic mould, usable by the invention, during precision casting and in the case of methods with lost models (lost foam) enables respectively the production of a burr-free cast part with protruding surface; merely the casting system must be separated and subsequently machined. The individual process steps are thereby able to be automated in particular for series production.

It becomes possible by means of the invention to produce cast coils with materials, such as Al and Cu or Al- and Cu alloys in large series and hence to increase significantly the productivity, design freedom and profitability in series use. Furthermore, with the described procedure, other materials, to be processed by casting technology, can be brought into a helical geometry. Furthermore, different spirals with different winding numbers, winding thicknesses and winding widths can be produced in an external shape with optionally different inner insets, for example made of ceramic material, hence a variant design is made possible. With the present invention, hence a substantial contribution to economic production of spirals, e.g. for use as coil in electric machines, is made and new manufacturing methods for electrical machines with higher power density and higher efficiency relative to the state of the art are opened up. By using the innovative concept for the production of spirals/coils or models for coils or lost moulds for coils in geometrically simply formed moulds, robust and automatable manufacturing processes for large series are made possible.

In addition to the conventional casting methods, such as pressure casting, low-pressure casting, sand casting, lost foam core packet methods, gravity casting, tilting shell casting, precision casting and the various derivatives, the geometry can be adjusted in order to pour the melt into one half in the mould with the described contour, to close the mould and hence to distribute the melt in the contour analogously to a waffle maker.

Simple visual examinations of the casting bodies and a metallographic analysis shed light on the manufacturing-caused history and production type of the moulded parts. In particular, plastically reshaped regions in the winding and the winding head can be detected metallographically.

1. Method for the production of a helical metal body (1′) in which firstly a preformed, helical metal body (1, 13) is produced in a mould by a casting method and thereupon is compressed by deformation along its longitudinal axis (6).

2. Method according to claim 1, characterised in that the metal body (1, 13) is compressed along its longitudinal axis (6) at least partially by plastic deformation after the casting.

3. Method according to claim 1 or 2, characterised in that the metal body (1, 13) is machined after the casting and before the compression, in particular by grinding and/or polishing and/or coating.

4. Method according to one of claims 1 to 3, characterised in that, for compression of the helical metal body (1, 13), the latter is pushed onto a mandrel (7) with a free end (7a) and a first stop shoulder (7b) and in that the free end (7a) of the mandrel is inserted into a receiving means (8) with a second stop shoulder (8a) until the metal body is compressed between the stop shoulders (7b, 8a).

5. Method according to one of claims 1 to 4, characterised in that, during production of the preformed metal body (1, 13) in each winding (3, 4, 5) of the spiral, at least one, in particular at least two deformation regions (10, 11, 12, 13) are provided or produced, in particular by a material cross-sectional tapering, and are deformed at first plastically during compression of the metal body.

6. Method according to one of claims 1 to 5, characterised in that the metal body (1′) is fixed by fixing means (9) with respect to its length after the compression.

7. Method for the production of a helical metal body (1′) according to one of claims 1 to 6, characterised in that firstly a lost model body, for example a foam part for a lost foam method, in particular made of a non-metallic material, is produced in the desired target shape of the compressed coiled metal body (1′) in that the model body is expanded by predeformation along the longitudinal axis and in that the expanded model body is used as positive mould for the casting of the predeformed metal body (1), in particular by producing a mould for the casting method with the help of the model body or by use in a melting method.

8. Device for the production of a coiled metal body (1′, 13′) according to one of claims 1 to 7, having a mandrel (7) which has a free end (7a) and, at a spacing from the free end, a first stop shoulder (7b) which is dimensioned such that it forms a limit stop for a coiled metal body (1, 1′, 13, 13′) pushed onto the mandrel and having a receiving means (8) which has an opening (8b) for inserting the free end of the mandrel and also a second stop shoulder (8a) for the metal body, surrounding the opening.

9. Device according to claim 8, characterised in that the mandrel (7) has outer dimensions, in the region which abuts on the first stop shoulder (7b), which enable a form-fit receiving of the preformed metal body (1) and in that the mandrel tapers to its free end (7a) in at least a first extension direction of its cross-section.

10. Device according to claim 8 or 9, characterised in that, as a result of the shaping of the mandrel (7) and of the receiving means (8), a longitudinal stop for insertion of the mandrel into the receiving means is formed, which fixes the length of the compressed helical metal body (1′, 13′).
